(19) United States
(12) Patent Application Publication
(10) Pub. No.: US 2024/0293961 A1
(43) Pub. Date: Sep. 5, 2024

(54) FOAMING DEVICE FOR FOAMING AN EXPANDABLE PARTICULATE FOAM MATERIAL

(71) Applicant: Fill Gesellschaft m.b.H., Gurten (AT)

(72) Inventors: Harald SEHRSCHOEN, Waldzell (AT); Heinz HOHENSINNER, Reichersberg (AT)

(73) Assignee: Fill Gesellschaft m.b.H., Gurten (AT)

(21) Appl. No.: 18/572,284

(22) PCT Filed: Jun. 20, 2022
(86) PCT No.: PCT/AT2022/060207

§ 371 Date: Feb. 20, 2024

(30) Foreign Application Priority Data
Jun. 21, 2021 (AT) A 50499/2021

(51) Int. Cl. B29C 44/34; B29C 44/54

(52) U.S. Cl. CPC B29C 44/3461; B29C 44/3415; B29C 44/54

(57) ABSTRACT

In an expanding device for expanding an expandable particle foam material with an expansion furnace which has an interior space for receiving the expandable particle foam material, a radiator is formed which is arranged in the interior space of the expansion furnace, and a conveying device with a conveying surface is formed, which serves to guide a particle foam material received on the conveying surface in a conveying direction through the interior space of the expansion furnace.

The invention relates to an expanding device for expanding an expandable particle foam material.

Polymer foams, in particular those made of polystyrene (PS), erythropoietic protoporphyry (EPP) or expanded thermoplastic polyurethane (eTPU), are processed in a multi-stage process from the starting product, a polystyrene granulate and/or polystyrene beads, to the finished foam part, e.g. thermal insulation panels, molded thermal insulation parts or transport packaging, in particular in vehicles, for structural reinforcement, for noise insulation or for weight reduction. In a pre-expansion process, the granulate loaded with blowing agent is pre-expanded to form foam beads and/or the intermediate foam product thus causing a volume increase, wherein this intermediate foam product essentially determines the mechanical and thermal properties of the end product. A polymer foam, in particular a polystyrene particle foam, is currently the most important material for the thermal insulation of old and/or new buildings. In the course of further legal requirements, an ever better thermal insulation of buildings is demanded, which can be achieved by increasing the thickness of the thermal insulation layer or reducing the thermal conductivity of the insulation material. The mechanical strength is just as important for practical applications, wherein it is known that an increased strength is associated with an increased material input of the base material. However, a larger quantity of the base material worsens the thermal insulation properties, so that a compromise must be found here. It is also known from the literature that the thermal conductivity can be reduced by increasing the cell/wall thickness ratio. This makes it possible to vary the thermal conductivity virtually independently of the mechanical properties.

Various methods and devices for producing particle foam materials are known from EP 0 348 372 B1, U.S. Pat. No. 3,015,479 A, AT 518 099 A1 and DE 10 2013 225 132 A1. These methods and devices have the disadvantage that only an inadequate expansion result and thus an excessively high density of the material can be achieved.

The object of the present invention was to overcome the shortcomings of the prior art and to provide a device and a method by means of which an improved expansion result can be achieved.

This object is achieved by means of a device and a method according to the claims.

According to the invention, an expanding device for expanding an expandable particle foam material is formed. The expanding device comprises an expansion furnace which has an interior space for receiving the expandable particle foam material, wherein an emitter is formed which is arranged in the interior space of the expansion furnace, and wherein a conveying device is formed with a conveying surface which serves to guide a particle foam material received on the conveying surface in a conveying direction through the interior space of the expansion furnace.

The device according to the invention entails the advantage that an improved expansion result of particle foam material can be achieved.

Furthermore, it may be useful if the interior space of the expansion furnace is bounded on an upper side by the emitter and bounded on a lower side by the conveying surface of the conveying device and bounded laterally by a first reflective element and a second reflective element. This entails the advantage that the radiation from the emitter can be reflected by the reflective elements and uniform radiation can be achieved on the particle foam material. In addition, the reflective elements can be used to ensure that the individual particles of the particle foam material are not only irradiated from above, but also from the side, in order to achieve uniform irradiation of the individual particles of the particle foam material.

In an advancement, it may be provided that the reflective elements are configured in the form of mirrored metal sheets. This entails the advantage that reflective elements configured in this way are easy to manufacture and are also robust.

Furthermore, it may be provided that the first reflective element and the second reflective element are each arranged at an acute angle to the emitter, wherein a first distance between the first reflective element and the second reflective element in the region of the emitter is greater than a second distance between the first reflective element and the second reflective element in the region of the conveying device, in particular that the first reflective element and the second reflective element are each arranged at an angle of between 70° and 98°, in particular between 90° and 95°, preferably between 92.5° and 94.5° to the emitter. This entails the advantage that a surprisingly uniform and surprisingly good heat input into the particle foam material can be achieved with such an arrangement of the reflective elements.

Moreover, it may be provided that receiving troughs are formed on the conveying surface of the conveying device, wherein the receiving troughs each serve to receive a single particle of the particle foam material. This entails the advantage that it can be achieved for each particle of the particle foam material that it does not rest against neighboring particles in the non-expanded state. This can prevent uneven expansion of the individual particles and/or a deformation of the individual particles of the particle foam material during the expansion process.

Furthermore, it may be provided that a radius of the receiving trough is between 1.5 mm and 4 mm, in particular between 1.8 mm and 3 mm, preferably between 2 mm and 2.5 mm.

Furthermore, it may be provided that a depth of the receiving trough is between 0.1 mm and 3 mm, in particular between 0.3 mm and 2 mm, preferably between 0.6 mm and 1.5 mm.

Moreover, it may be provided that a surface diameter of the receiving trough is between 0.2 mm and 4 mm, in particular between 0.3 mm and 2 mm, preferably between 0.5 mm and 1.2 mm.

In particular, a receiving trough shaped according to the above specifications entails the surprising advantage that only a single particle of the particle foam material is received in the respective receiving trough in order to achieve a correspondingly isolated provision of the particles of the particle foam material on the conveying surface.

In an alternative embodiment variant, it may be provided that a mesh structure is formed which defines the receiving troughs. This entails the advantage that the mesh structure can serve to hold the individual particles of the particle foam material.

In particular, it may be provided that a conveyor floor is formed below the mesh structure, wherein the mesh structure is displaced relative to the conveyor floor. This can ensure that the individual particles of the particle foam material are guided through the mesh structure and rest on the conveyor floor and/or roll off the conveyor floor. By rolling the individual particles of the particle foam material on the conveyor floor, a circumferentially uniform heating and thus uniform expansion of the particles of the particle foam material can be achieved.

According to an advancement, it is possible that the conveying surface of the conveying device comprises a thermally activatable material which is configured in such a way that an extension of the receiving troughs increases when heated. This entails the advantage that, by this measure, the dimensioning of the conveying surface of the conveying device, in particular the trough and/or mesh structure, can be heated simultaneously with the individual particles of the particle foam material when heated. This allows the conveying surface to adapt to the changing size of the individual particles of the particle foam material.

Furthermore, it may be useful if multiple feed channels are formed, wherein the feed channels are arranged next to one another as viewed in the conveying direction, wherein the feed channels are each aligned with a row of receiving troughs. This entails the advantage that the particles of the particle foam material can be directed specifically into the receiving troughs by means of the feed channels and/or can be placed in them.

Furthermore, it is conceivable that a bulk container, into which the individual particles of the particle foam material can be poured, is formed above the feed channels. The feed channels can be connected directly to the bulk container.

In an advancement, it may be provided that the individual feed channels are coupled to a vibrator device by means of which the feed channels can be caused to vibrate. This entails the advantage that, by this measure, the particles fed into the bulk container can be easily separated and conveyed into the feed channel.

Moreover, it may be provided that the feed channels each have a feed channel diameter and that the particles of the particle foam material have a particle diameter, wherein the feed channel diameter is between 100.1% and 199%, in particular between 105% and 170%, preferably between 110% and 130% of the particle diameter. By this measure, it can be achieved that the individual particles of the particle foam material can be easily separated in the feed channel.

Furthermore, it may be provided that the feed channels are each arranged at a feed channel distance from the conveying surface of the conveying device, wherein the particle diameter is between 100.1% and 199%, in particular between 105% and 170%, preferably between 110% and 130% of the feed channel distance. By this measure, it can be achieved that a particle of the particle foam material can only exit the feed channel when it is received in a receiving trough. As a result, improved separation and/or uniform application of the individual particles of the particle foam material to the conveying surface can be achieved.

In an alternative embodiment, it can be provided that the particle diameter is between 51% and 99.9%, in particular between 70% and 98%, preferably between 80% and 90% of the feed channel spacing. In such an embodiment, a separation of the particles of the particle foam material can also be achieved if the conveying surface is configured as a flat surface, at least in some regions, which has no troughs.

In a first embodiment variant, it may be provided that the conveying surface of the conveying device is formed on a circulating belt. In particular, it may be provided that such a belt is configured in the form of a metallic belt, in particular in the form of a stainless steel belt.

In an alternative embodiment variant, it may be provided that the conveying surface of the conveying device is formed on a flat transport device, in particular on a support plate. Furthermore, it may be provided that the support plate has receiving troughs in the form of a perforation of multiple holes.

According to a particular embodiment, it is possible that, as viewed in the conveying direction, at least a first plane and a second plane of receiving troughs are formed, wherein the individual receiving troughs of the first plane are arranged in multiple rows and wherein the individual receiving troughs of the second plane are arranged in multiple rows. This entails the advantage that a higher deposition density of the individual particles of the particle foam material on the conveying surface can be achieved.

According to an advantageous advancement, it may be provided that a scraper is formed in a feed region, wherein the scraper is arranged at a scraper distance from the conveying surface of the conveying device, wherein the particle diameter is between 50% and 99.9%, in particular between 70% and 97%, preferably between 85% and 92% of the scraper distance.

This entails the advantage that a separation of the particles of the particle foam material on the conveying surface of the conveying device can be achieved by means of the scraper.

In particular, it can be advantageous if a cooling device is formed which serves to cool the particle foam material. Thereby, a surprising improvement in the expansion quality of the particle foam material can be achieved. In particular, it may be provided that the cooling device is formed in the region of the conveying device. Furthermore, it may be provided that the cooling device is arranged on a bottom side of a conveyor belt, in particular on the side of the conveyor belt opposite the conveying surface.

Furthermore, it may be provided that a separating device is formed, which serves to separate individual particles of the particle foam material from one another. This entails the advantage that particles of the particle foam material that adhere together can be easily separated from one another by the separating device. In particular, it may be provided that the separating device is configured in the form of a spiked roller, which serves to break up particle agglomerates.

In a first exemplary embodiment, it is conceivable that the separating device is used to separate individual expanded particles of the particle foam material, wherein the separating device is arranged downstream of the emitter. Alternatively or additionally, it is also conceivable that the separating device is used to separate particles of the particle foam material that are still to be expanded, wherein the separating device is arranged upstream of the emitter. The separating device can include a device for emitting air blasts. The separation of the particles can thus be supported by air blasts or, depending on the material, be performed only by air blasts.

Moreover, it may be provided that an intermediate storage and a further expansion furnace are formed, wherein the intermediate storage is arranged downstream of the expansion furnace and the further expansion furnace is arranged downstream of the intermediate storage as viewed in the conveying direction. This entails the advantage that the pre-expanded particle foam material can be cooled in the intermediate storage and/or can spend a rest period in it in order to achieve an improved expansion result.

An embodiment, according to which it may be provided that a vibrator device is formed which acts on the conveying surface of the conveying device, is also advantageous. By this measure, it can be achieved that the individual particles of the particle foam material can rotate during conveying in order to achieve uniform irradiation of the particles and thus uniform heating of the particles. In particular, it may be provided that the vibrator device is configured to emit an ultrasonic vibration.

Furthermore, it may be provided that the emitter is configured in the form of an infrared emitter. In a further embodiment variant, it may be provided that the emitter is configured in the form of another device emitting thermal energy.

According to the invention, a method for expanding an expandable particle foam material in the form of a granulate material of individual particles is provided, wherein the method comprises the method steps:
applying the particle foam material to a conveying surface of a conveying device;
introducing the particle foam material into an interior space of an expansion furnace by means of the conveying device;
irradiating the particle foam material by means of an emitter arranged in the interior space of the expansion furnace;
removing the particle foam material from the interior space of the expansion furnace.

The method according to the invention entails the advantage that an improved expansion result of particle foam material can be achieved.

According to an advancement, it is possible that after the particle foam material has been removed from the interior space of the expansion furnace, the particle foam material is temporarily stored in an intermediate storage and subsequently fed into a further expansion furnace. This entails the advantage that the pre-expanded particle foam material can be cooled in the intermediate storage and/or can spend a rest period in it in order to achieve an improved expansion result.

Furthermore, it may be provided that the conveying device is advantageously configured as trays or coupled fields. These can also be displaced laterally or transversely to the conveying direction, e.g. stacked. This allows the conveying length to be reduced, buffer spaces to be created or cooling stations to be fed.

Furthermore, it may be provided that the trays or elements of the conveying device that form the conveying surface are cooled with a cooling medium operated in the cooling circuit.

In particular, it is advantageous in this regard if the particles of the particle foam material are cooled by means of contact cooling. In an advancement, it is conceivable that a spray mist of the cooling medium is used for cooling.

In this regard, after passing through the interior space of the expansion furnace, the trays can be returned outside the interior space of the expansion furnace in order to enable a cycle of conveying the trays.

In an advantageous embodiment variant, it may be provided that the trays or fields are formed from a moldable and/or pressable material in order to be able to form receiving troughs and structures therein.

It can also be advantageous if the trays are coupled with mesh structures in which the receiving troughs are formed.

In particular, it is conceivable that the mesh structure is configured in such a way that the mesh width can be changed.

For the purpose of better understanding of the invention, it will be elucidated in more detail by means of the figures below.

These show in a respectively very simplified schematic representation:

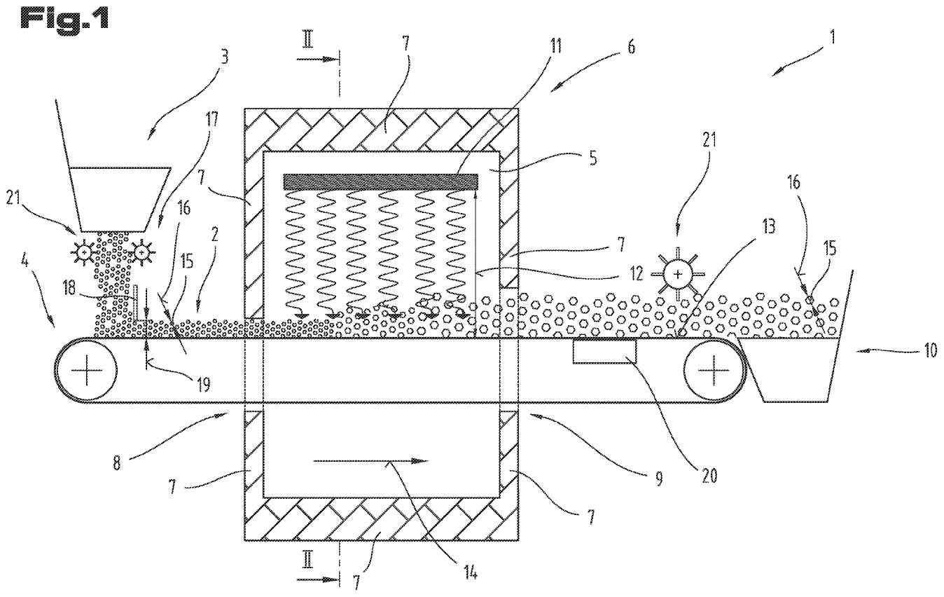

FIG. 1 a longitudinal section of a first exemplary embodiment of an expanding device with an expansion furnace;

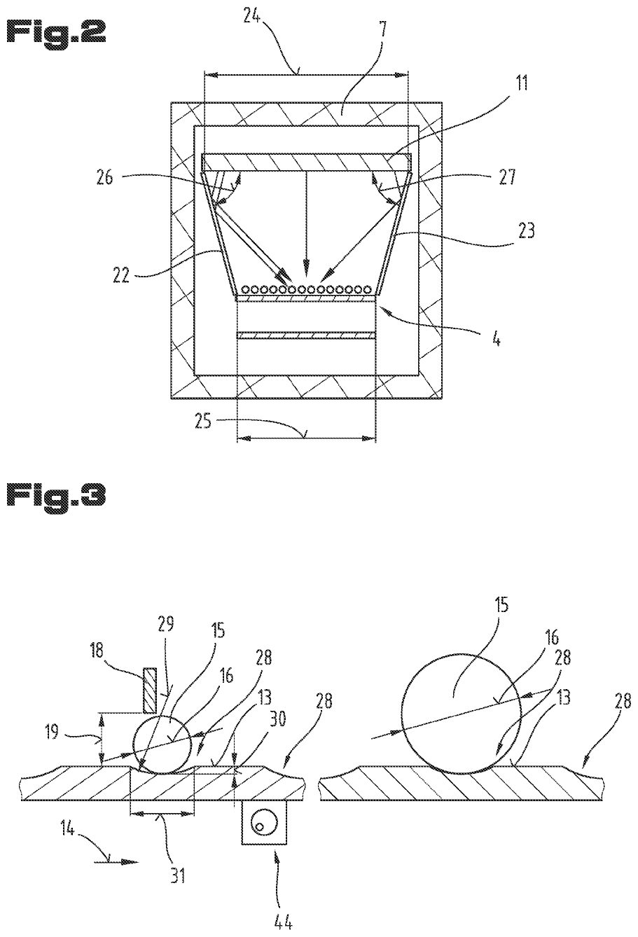

FIG. 2 a cross section of the first exemplary embodiment of the expanding device;

FIG. 3 a detail view of a conveying surface with receiving troughs in a longitudinal section;

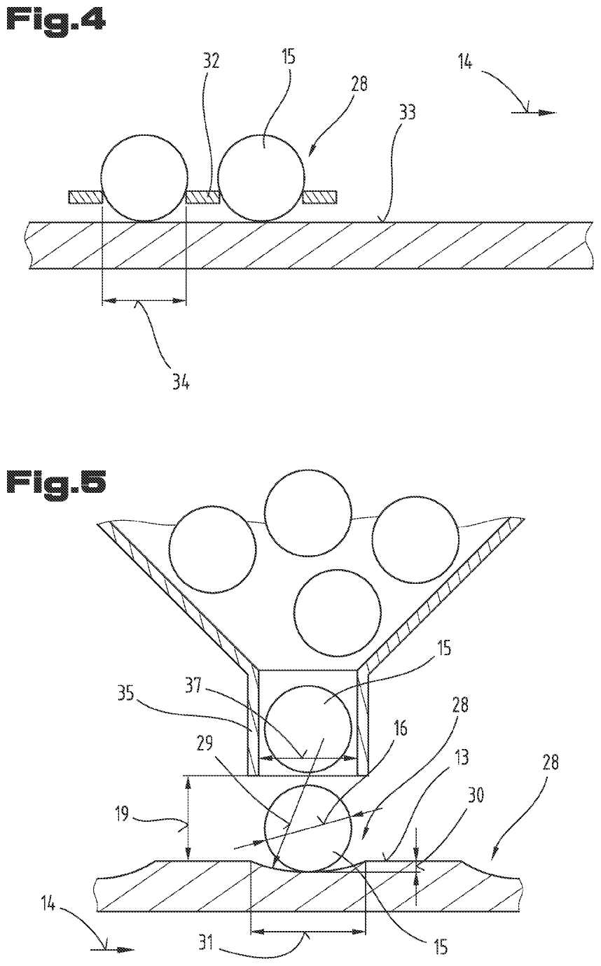

FIG. 4 a detail view of a further embodiment variant of the conveying device with a mesh structure;

FIG. 5 a detail view of a feed channel;

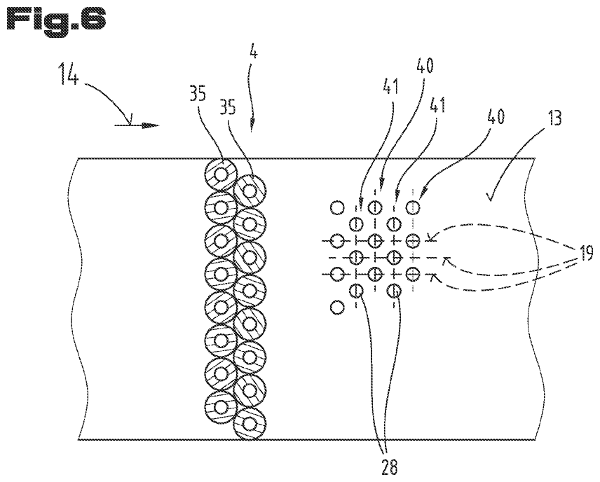

FIG. 6 a top view onto a conveying surface with receiving troughs and multiple feed channels;

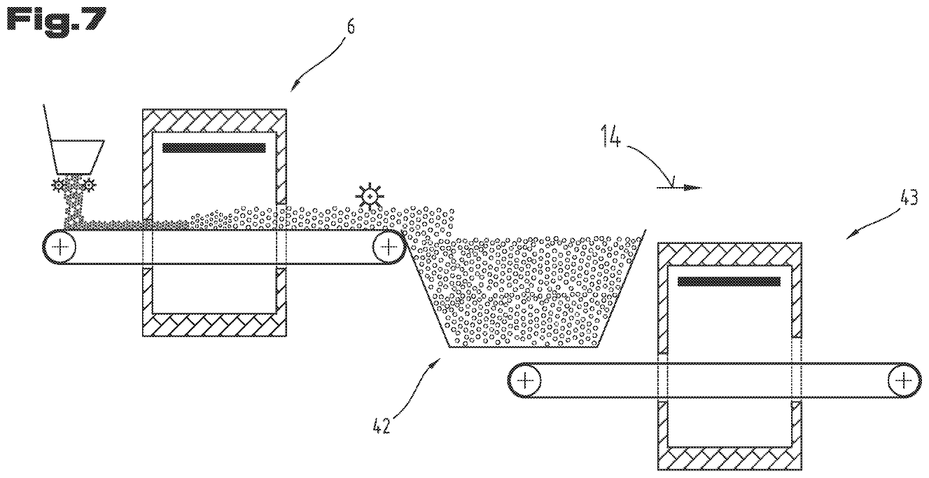

FIG. 7 a further exemplary embodiment of the expanding device with the expansion furnace, an intermediate storage and a further expansion furnace.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

FIG. 1 shows a first exemplary embodiment of an expanding device 1 for expanding particle foam material 2.

The expanding device 1 may comprise a granulate provision device 3 by means of which the particle foam material 2 can be fed onto a conveying device 4.

The conveying device 4 can run through an interior space 5 of an expansion furnace 6 in which the particle foam material 2 can be expanded. Expansion is understood to mean increasing the volume of the particle foam material 2.

The interior space 5 of the expansion furnace 6 can be bounded by multiple walls 7, which can provide insulation of the interior space 5 of the expansion furnace 6.

In particular, it may be provided that an inlet opening 8 and/or an outlet opening 9, through which the conveying device 4 is guided, is formed in two opposing walls 7. The inlet opening 8 and/or the outlet opening 9 are preferably dimensioned as small as possible so that they are as close as possible to the conveying device 4 and/or to the particle foam material 2 held on the conveying device 4. Thereby, an air exchange between the interior space 5 of the expansion furnace 6 and the surroundings of the expansion furnace 6 can be largely prevented. Thus, convection between the interior space 5 of the expansion furnace 6 and the exterior space of the expansion furnace 6 can also be largely avoided. This leads to a particularly good expansion result.

Furthermore, a removal device 10 can be formed into which the expanded particle foam material 2 can be transported by means of the conveying device 4.

The expanding device 1 according to the exemplary embodiment according to FIG. 1 is a continuously operating expanding device 1. In this regard, the conveying device 4 can be configured in the form of a belt conveyor. A conveying surface 13 for receiving the particle foam material 2 can be formed on a conveyor belt in this regard. The particle foam material 2 can be conveyed through the expansion furnace 6 in the conveying direction 14 by means of the conveying device 4.

Alternatively, it is also possible for the conveying device 4 to be configured in the form of a screw conveyor or a scraper floor conveyor, for example. A further exemplary embodiment of the conveying device 4 is described with reference to FIG. 4.

As can be seen from FIG. 1, it may be provided that an emitter 11, which serves to stimulate the expansion process of the particle foam material 2, is arranged in the interior space 5 of the expansion furnace 6. The emitter 11 is only shown schematically in FIG. 1. The emitter 11 is spaced at a distance 12 from the conveying surface 13 of the conveying device 4.

In a first exemplary embodiment, it may be provided that the emitter is slidably accommodated in the interior space 5 of the expansion furnace 6 so that the distance 12 can be varied.

In a further exemplary embodiment, it may also be provided that the emitter 11 is fixed in the interior space 5 of the expansion furnace 6.

The emitter 11 can be configured as an infrared emitter, which generally comprises a metal housing that provides the necessary stability. Insulation material, which blocks the flow of energy to the rear of the emitter, is integrated into the metal frame. A corrugated metal foil as a resistor material ensures a large radiation surface. There is usually a protective grille at the front to protect against mechanical damage and contact. An IR emitter constructed in this way is characterized by wide-area radiation. For example, such an emitter 11 can be operated at a temperature of 850° C., which corresponds to a wavelength of approx. 3.5 μm.

As can also be seen from FIG. 1, it may be provided that the particle foam material 2 comprises individual particles 15. The particles 15 have a particle diameter 16. As can be seen from FIG. 1, the particle diameter 16 can increase when the particle foam material 2 is heated and/or irradiated.

Furthermore, it may be provided that a scraper 18 is formed in a feed region 17. The scraper 18 can be arranged at a scraper distance 19 from the conveying surface 13 of the conveying device 4. In particular, the scraper 18 can serve to regulate the distribution of the individual particles 15 of the particle foam material 2 on the conveying surface 13.

As can also be seen from FIG. 1, it can be provided that a cooling device 20 is formed, which serves to cool the particle foam material 2. The cooling device 20 can be arranged downstream of the emitter 11 as seen in the conveying direction 14. In particular, it may be provided that the cooling device 20 is arranged below the conveying surface 13 in order to be able to cool the particle foam material 2 from below. In an alternative embodiment variant, it may also be provided that the cooling device 20 is configured for direct cooling of the particle foam material 2 from above.

As can also be seen from FIG. 1, it can be provided that a separating device 21, which serves to separate individual particles 15 of the particle foam material 2 from one another, is formed in the feed region 17 and/or downstream of the emitter 11. In the present exemplary embodiment, the separating device 21 is configured as a mechanical separating device.

In FIG. 2, the expanding device 1 is shown in a cross-sectional view according to the sectional line II-II in FIG. 1, wherein again, equal reference numbers and/or component designations are used for equal parts as in the preceding FIG. 1. In order to avoid unnecessary repetitions, it is pointed to/reference is made to the detailed description in FIG. 1 preceding it.

As can be seen in FIG. 2, it can be provided that a first reflective element 22 and a second reflective element 23 are arranged laterally to the conveying device 4. The reflective elements 22, 23 serve to reflect the radiation emitted by the emitter 11 in order to achieve a uniform effect of the radiation on the conveying surface 13.

As can be seen from FIG. 2, it can be provided that the reflective elements 22, 23 are arranged in a V-shape in relation to one another, so that a first distance 24 between the first reflective element 22 and the second reflective element 23 in the region of the emitter 11 is greater than a second distance 25 between the first reflective element 22 and the second reflective element 23 in the region of the conveying device 4.

As can be seen from FIG. 2, it may be provided that the first reflective element 22 is arranged at a first angle 26 to the emitter 11. In this regard, the first angle 26 is measured on the side facing the second reflective element 23. Furthermore, it may be provided that the second reflective element 23 is arranged at a second angle 27 to the emitter 11. In this regard, the second angle 27 is measured on the side facing the first reflective element 22.

FIG. 3 shows a detailed view of a conveying surface 13 with receiving troughs 28 in a longitudinal section, wherein again, equal reference numbers and/or component designations are used for equal parts as before in FIGS. 1 and 2. In order to avoid unnecessary repetitions, it is pointed to/reference is made to the detailed description in FIGS. 1 and 2 preceding it.

FIG. 3 shows a detailed view of the conveying surface 13, wherein the conveying surface 13 is shown in such a way that a non-expanded particle 15 is shown in the conveying flow and an already expanded particle 15 is shown to the right of it. As can be seen from FIG. 3, it may be provided that receiving troughs 28, which serve to receive the individual particles 15 of the particle foam material 2, are formed on the conveying surface 13.

The receiving troughs 28 can be formed as a spherical cap and/or in the form of a spherical section and have a radius 29. Furthermore, the receiving troughs 28 can have a depth 30. Furthermore, the receiving troughs 28 can have a surface diameter 31. The surface diameter 31 is the diameter that lies at the outermost point of the conveying surface 13.

In the representation according to FIG. 3, the conveying device 4 and/or the conveying surface 13 is shown cut exactly through the center of one of the receiving troughs 28.

As can also be seen from FIG. 3, it may be provided that a scraper 18 is provided, wherein a scraper distance 19 is dimensioned such that the particle 15, if it is located in the receiving trough 28, is allowed to pass under the scraper 18 and the particle 15, if it is located outside the receiving trough 28, is held back by the scraper 18 so that it cannot be conveyed in the conveying direction 14 until another free receiving trough 28 is moved into the region of the particle 15.

As can also be seen from FIG. 3, it may be provided that a vibrator device 44 is formed which acts on the conveying surface 13 of the conveying device 4.

FIG. 4 shows a detailed view of a further embodiment variant of the conveying device 4, wherein again, equal reference numbers and/or component designations are used for equal parts as in FIGS. 1 through 3 above. In order to avoid unnecessary repetitions, it is pointed to/reference is made to the detailed description in FIGS. 1 through 3 preceding it.

As can be seen from FIG. 4, it can be provided that the conveying device 4 comprises a mesh structure 32 by means of which the individual particles 15 are kept at a distance and by means of which the particles 15 can be moved in the conveying direction 14. In this regard, the individual particles 15 can rest on a fixed conveyor floor 33 so that they roll off the conveyor floor 33. In particular, it may be provided that receiving troughs 28, which have an extension 34, are formed by the mesh structure 32.

FIG. 5 shows a detailed view of a further embodiment variant of the expanding device 1, wherein again, equal reference numbers and/or component designations are used for equal parts as in FIGS. 1 through 4 above. In order to avoid unnecessary repetitions, it is pointed to/reference is made to the detailed description in FIGS. 1 through 4 preceding it.

As can be seen from FIG. 5, it can be provided that a feed channel 35 is formed, which is used to feed the individual particles 15 onto the conveying surface 13. The feed channel 35 can be coupled to a bulk container 36 into which the individual particles 15 can be fed. Furthermore, it may be provided that the feed channel 35 is cylindrical and has a feed channel diameter 37. The feed channel 35 can be arranged at a feed channel distance 38 from the conveying surface 13. The feed channel distance 38 can be dimensioned in such a way that the particle 15, if it is located in the receiving trough 28, is allowed to pass under the feed channel 35 and the particle 15, if it is located outside the receiving trough 28, is held back by the feed channel 35 so that it cannot be conveyed in the conveying direction 14 until another free receiving trough 28 is moved into the region of the particle 15.

FIG. 6 shows a detailed view of a further embodiment variant of the expanding device 1, wherein again, equal reference numbers and/or component designations are used for equal parts as in FIGS. 1 through 5 above. In order to avoid unnecessary repetitions, it is pointed to/reference is made to the detailed description in FIGS. 1 through 5 preceding it.

FIG. 6 shows a top view of the conveying surface 13 of the conveying device 4. As can be seen from FIG. 6, it may be provided that the individual receiving troughs 28 are arranged in multiple rows 39. Furthermore, it may be provided that at least a first plane 40 and a second plane 41 of receiving troughs 28 are formed as viewed in the conveying direction. By forming a first plane 40 and a second plane 41 of receiving troughs 28, the receiving capacity of the conveying surface 13 can be increased.

As can also be seen from FIG. 6, it can also be provided that a plurality of feed channels 35 are arranged across the width of the conveying device 4 transversely to the conveying direction 14, wherein the individual feed channels 35 are aligned with the rows 39 of receiving troughs 28. In this regard, the individual feed channels 35 can also be arranged in multiple planes. Furthermore, it may be provided that the individual feed channels 35 are coupled to a common bulk container 36. Furthermore, it may be provided that the feed channels 35 and/or the bulk container 36 are subjected to a vibration in order to separate the particles 15.

FIG. 7 shows a detailed view of a further embodiment variant of the expanding device 1, wherein again, equal reference numbers and/or component designations are used for equal parts as in FIGS. 1 through 6 above. In order to avoid unnecessary repetitions, it is pointed to/reference is made to the detailed description in FIGS. 1 through 6 preceding it.

As can be seen from FIG. 7, it may be provided that, as viewed in the conveying direction 14, an intermediate storage 42 is arranged downstream of the emitter 11, which is used for intermediate storage and/or for cooling of the particles 15. A further expansion furnace 43 can be arranged downstream of the intermediate storage 42.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the technical teaching provided by the present invention lies within the ability of the person skilled in the art in this technical field.

The scope of protection is determined by the claims. Nevertheless, the description and drawings are to be used for construing the claims. Individual features or feature combinations from the different exemplary embodiments shown and described may represent independent inventive solutions. The object underlying the independent inventive solutions may be gathered from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

List of reference numbers

| | |
|---|---|
| 1 | Expanding device |
| 2 | Particle foam material |
| 3 | Granulate provision device |
| 4 | Conveying device |
| 5 | Interior space |
| 6 | Expansion furnace |
| 7 | Wall |
| 8 | Inlet opening |
| 9 | Outlet opening |
| 10 | Removal device |
| 11 | Emitter |
| 12 | Distance |
| 13 | Conveying surface |
| 14 | Conveying direction |
| 15 | Particle |
| 16 | Particle diameter |
| 17 | Feed region |
| 18 | Scraper |
| 19 | Scraper distance |
| 20 | Cooling device |
| 21 | Separating device |
| 22 | First reflective element |
| 23 | Second reflective element |
| 24 | First distance |
| 25 | Second distance |
| 26 | First angle |
| 27 | Second angle |
| 28 | Receiving trough |
| 29 | Radius of receiving trough |
| 30 | Depth of receiving trough |
| 31 | Surface diameter of receiving trough |
| 32 | Mesh structure |
| 33 | Conveyor floor |
| 34 | Extension |
| 35 | Feed channel |
| 36 | Bulk container |
| 37 | Feed channel diameter |
| 38 | Feed channel distance |
| 39 | Row |
| 40 | First plane |
| 41 | Second plane |
| 42 | Intermediate storage |
| 43 | Further expansion furnace |
| 44 | Vibrator device |

1. An expanding device (1) for expanding an expandable particle foam material (2) with an expansion furnace (6) which has an interior space (5) for receiving the expandable particle foam material (2), wherein a radiator (11) is formed which is arranged in the interior space (5) of the expansion furnace (6), and wherein a conveying device (4) with a conveying surface (13) is formed, which serves to guide a particle foam material (2) received on the conveying surface (13) in a conveying direction (14) through the interior space (5) of the expansion furnace (6).

2. The expanding device (1) according to claim 1, wherein the interior space (5) of the expansion furnace (6) is bounded on an upper side by the emitter (11) and bounded on a lower side by the conveying surface (13) of the conveying device (4) and bounded laterally by a first reflective element (22) and a second reflective element (23).

3. The expanding device (1) according to claim 2, wherein the first reflective element (22) and the second reflective element (23) are each arranged at an acute angle to the emitter (11), wherein a first distance (24) between the first reflective element (22) and the second reflective element (23) in the region of the emitter (11) is greater than a second distance (25) between the first reflective element (22) and the second reflective element (23) in the region of the conveying device (4), in particular the first reflective element (22) and the second reflective element (23) are each arranged at an angle (26, 27) of between 70° and 98°, in particular between 90° and 95°, preferably between 92.5° and 94.5° to the emitter (11).

4. The expanding device (1) according to claim 1, wherein receiving troughs (28) are formed on the conveying surface (13) of the conveying device (4), wherein the receiving troughs (28) each serve to receive a single particle (15) of the particle foam material (2).

5. The expanding device (1) according to claim 1, wherein a mesh structure (32) is formed which defines the receiving troughs (28).

6. The expanding device (1) according to claim 4, wherein the conveying surface (13) of the conveying device (4) comprises a thermally activatable material which is configured in such a way that an extension (34) of the receiving troughs (28) increases when heated.

7. The expanding device (1) according to claim 1, wherein multiple feed channels (35) are formed, wherein the feed channels (35) are arranged next to one another as viewed in the conveying direction (14), wherein the feed channels (35) are each aligned with a row (39) of receiving troughs (28).

8. The expanding device (1) according to claim 7, wherein the feed channels (35) each have a feed channel diameter (37) and wherein the particles (15) of the particle foam material (2) have a particle diameter (16), wherein the feed channel diameter (37) is between 100.1% and 199%, in particular between 105% and 170%, preferably between 110% and 130% of the particle diameter (16).

9. The expanding device (1) according to claim 7, wherein the feed channels (35) are each arranged at a feed channel distance (38) from the conveying surface (13) of the conveying device (4), wherein the particle diameter (16) is between 100.1% and 199%, in particular between 105% and 170%, preferably between 110% and 130% of the feed channel distance (38).

10. The expanding device (1) according to claim 7, wherein, as viewed in the conveying direction (14), at least a first plane (40) and a second plane (41) of receiving troughs (28) are formed, wherein the individual receiving troughs (28) of the first plane (40) are arranged in multiple rows (39) and wherein the individual receiving troughs (28) of the second plane (41) are arranged in multiple rows (39).

11. The expanding device (1) according to claim 1, wherein a scraper (18) is formed in a feed region (17), wherein the scraper (18) is arranged at a scraper distance (19) from the conveying surface (13) of the conveying device (4), wherein the particle diameter (16) is between 50% and 99.9%, in particular between 70% and 97%, preferably between 85% and 92% of the scraper distance (19).

12. The expanding device (1) according to claim 1, wherein a cooling device (20) is formed, which serves for cooling the particle foam material (2).

13. The expanding device (1) according to claim 1, wherein a separating device (21) is formed, which serves to separate individual particles (15) of the particle foam material (2) from one another.

14. The expanding device (1) according to claim 1, wherein an intermediate storage (42) and a further expansion furnace (43) are formed, wherein the intermediate storage (42) is arranged downstream of the expansion furnace (6) and the further expansion furnace (43) is arranged downstream of the intermediate storage (42) as viewed in the conveying direction (14).

15. The expanding device (1) according to claim 1, wherein a vibrator device (44) is formed, which acts on the conveying surface (13) of the conveying device (4).

16. A method for expanding an expandable particle foam material (2) in the form of a granulate material of individual particles (15), wherein the method comprises the following method steps:
applying the particle foam material (2) to a conveying surface (13) of a conveying device (4);
introducing the particle foam material (2) into an interior space (5) of an expansion furnace (6) by means of the conveying device (4);
irradiating the particle foam material (2) by means of an emitter (11) arranged in the interior space (5) of the expansion furnace (6); and
removing the particle foam material (2) from the interior space (5) of the expansion furnace (6).

17. The method according to claim 16, wherein, after the particle foam material (2) has been removed from the interior space (5) of the expansion furnace (6), the particle foam material (2) is temporarily stored in an intermediate storage (42) and subsequently fed into a further expansion furnace (43).
